(19) United States
(12) Patent Application Publication
(10) Pub. No.: US 2004/0246815 A1
(43) Pub. Date: Dec. 9, 2004

(54) Device and method of creating hydrodynamic cavitation in fluids

(76) Inventor: Oleg V. Kozyuk, Westlake, OH (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/760,606

(22) Filed: Jan. 16, 2004

Related U.S. Application Data
(63) Continuation-in-part of application No. 10/131,512, filed on Apr. 22, 2002, now abandoned.

(51) Int. Cl. B01F 5/06

(52) U.S. Cl. 366/336

(57) ABSTRACT

A device and method for creating hydrodynamic cavitation in fluids is disclosed. The device can include a chamber formed by at least one wall. The wall can have a first orifice configured to permit the introduction of a first liquid stream into the chamber and an opposing second orifice configured to permit the introduction of a second liquid stream into the chamber. The first orifice can have a diameter sufficiently smaller than the second orifice to permit penetration of the first liquid stream into the second liquid stream.

### BACKGROUND

The present application relates to a device and method for creating hydrodynamic cavitation in fluids. This device and method may find application in mixing, synthesis, assisting in chemical reactions, and sonochemical reactions in the chemical, food, pharmaceuticals, cosmetics processing, and other types of industry.

Cavitation is the formation of bubbles and cavities within a liquid stream resulting from a localized pressure drop in the liquid flow. If the pressure at some point decreases to a magnitude under which the liquid reaches the boiling point for this fluid, then a great number of vapor-filled cavities and bubbles are formed. As the pressure of the liquid then increases, vapor condensation takes place in the cavities and bubbles, and they collapse, creating very large pressure impulses and very high temperatures. According to some estimations, the temperature within the bubbles attains a magnitude on the order of 5000° C. and a pressure of approximately 500 kg/cm². Cavitation involves the entire sequence of events beginning with bubble formation through the collapse of the bubble. Because of this high energy level, cavitation has been studied for its ability to mix materials and aid in chemical reactions.

There are several different ways to produce cavitation in a fluid. The way known to most people is the cavitation resulting from a propeller blade moving at a critical speed through water. If a sufficient pressure drop occurs at the blade surface, cavitation will result. Likewise, the movement of a fluid through a restriction such as an orifice plate can also generate cavitation if the pressure drop across the orifice is sufficient. Both of these methods are commonly referred to as hydrodynamic cavitation. Cavitation may also be generated in a fluid by the use of ultrasound. A sound wave consists of compression and decompression cycles. If the pressure during the decompression cycle is low enough, bubbles may be formed. These bubbles will grow during the decompression cycle and contract or even implode during the compression cycle.

### BRIEF DESCRIPTION OF THE DRAWINGS

It will be appreciated that the illustrated boundaries of elements (e.g., boxes or groups of boxes) in the figures represent one example of the boundaries. One of ordinary skill in the art will appreciate that one element may be designed as multiple elements or that multiple elements may be designed as one element. An element shown as an internal component of another element may be implemented as an external component and vice versa.

Further, in the accompanying drawings and description that follow, like parts are indicated throughout the drawings and description with the same reference numerals, respectively. The figures are not drawn to scale and the proportions of certain parts have been exaggerated for convenience of illustration.

FIG. 1 illustrates a longitudinal cross-section of one embodiment of a device 100 for creating hydrodynamic cavitation.

FIG. 2 illustrates a longitudinal cross-section of another embodiment of a device 200 for creating hydrodynamic cavitation.

FIG. 3 illustrates a longitudinal cross-section of another embodiment of a device 300 for creating hydrodynamic cavitation.

FIG. 4 illustrates a longitudinal cross-section of another embodiment of a device 400 for creating hydrodynamic cavitation.

FIG. 5 illustrates a longitudinal cross-section of another embodiment of a device 500 for creating hydrodynamic cavitation.

### DETAILED DESCRIPTION

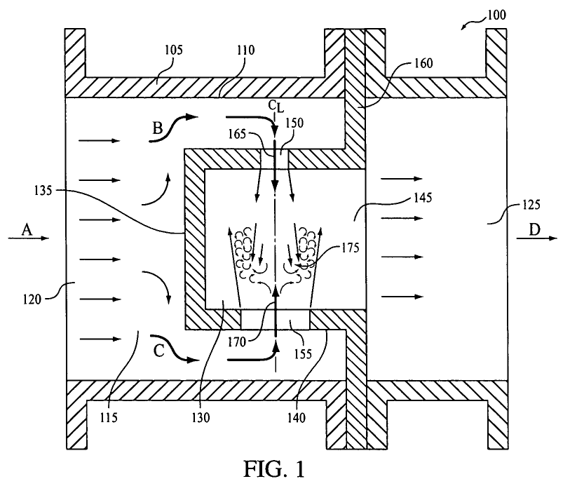

FIG. 1 illustrates a longitudinal cross-section of one embodiment of a device 100 for creating hydrodynamic cavitation. The device 100 can include at least one wall 105 having an inner surface 110 that defines a flow-through channel or chamber 115. For example, the wall 105 can be a cylindrical wall that defines a flow-through channel having a circular cross-section. It will be appreciated that the cross-section of flow-through channel 115 may take the form of other geometric shapes such as square, rectangular, hexagonal, or any other complex shape.

The flow-through channel 115 can further include an inlet 120 configured to introduce a liquid into the device 100 along a path, represented by arrow A, and an outlet 125 configured to exit the liquid from the device 100.

Situated within the flow-through channel 115 is a cavitation chamber 130 defined by a front wall 135 oriented substantially perpendicular to the flow-through channel 115, at least one side wall 140 oriented substantially parallel to the flow-through channel 115, and an exit opening 145 in communication with the outlet 125. It will be appreciated that although the illustrated cavitation chamber 130 is cylindrical in shape, it is contemplated that any shape may be possible provided that the liquid stream is permitted to enter the cavitation chamber 130. Suitable shapes may include cubical, conical, spherical, semi-spherical, or rectangular.

In one embodiment, the side wall 140 can include a first orifice 150 configured to permit the introduction of a first liquid stream into the cavitation chamber 130 and a second orifice 155, oriented opposite the first orifice 150, and configured to permit the introduction of a second liquid stream into the cavitation chamber 130. For example, the first orifice 150 and the second orifice 155 can directly face each other and share the same centerline CL.

In one embodiment, the diameter of the first orifice 150 can be sufficiently smaller than the second orifice 155 to permit penetration of the first liquid stream into the second liquid stream. For example, the diameter of the first orifice 150 can be at least 10% less than the diameter of the second orifice 155 to provide adequate penetration of the first liquid stream into the second liquid stream.

The cavitation chamber 130 can also include a flange 160 in communication with the side wall 140 and the flow-through channel 115 to direct fluid into the cavitation chamber 130 and restrict fluid from exiting the flow-through channel 115 without being directed into the first orifice 150 or second orifice 155.

In operation, a hydrodynamic liquid stream can move along the A direction through the inlet 120 and flow into the flow-through channel 115. As the liquid stream approaches the front wall 135, the liquid stream can be directed outwards towards the inner surface 110 of the wall 105. One portion of the liquid stream, indicated by arrow B, can pass around the front wall 135 and enter the first orifice 150 forming a liquid jet 165 (hereinafter referred to as “smaller liquid jet 165” because this liquid jet exits the smaller diameter orifice 150). Additionally, the other portion of the liquid stream, indicated by arrow C, can pass around the front wall 135 and enter the second orifice 155 forming a liquid jet 170 (hereinafter referred to as “larger liquid jet 170” because this liquid jet exits the larger diameter orifice 155).

Both the smaller liquid jet 165 and the larger liquid jet 170 can flow into the cavitation chamber 130 where they impinge along centerline CL. Once the smaller liquid jet 165 and the larger liquid jet 170 impinge, the smaller liquid jet 165 can penetrate and interact with the larger liquid jet 170 thereby creating a high shear intensity vortex contact layer 175 between the liquid jets 165, 170. As a result of this penetration and interaction, cavitation caverns and bubbles are created in the high shear intensity vortex contact layer 175. During the collapse of the cavitation caverns and bubbles, high localized pressures, up to 1000 MPa, arise and the level of energy dissipation in the flow-through channel 115 attains a magnitude in the range of 1¹⁰-1¹⁵ watt/kg. Under these physical conditions in the liquid, on the boundary of the bubble and inside the bubble itself in the gas phase, chemical reactions proceed such as oxidation, disintegration, synthesis, etc. After the cavitation bubbles collapse, the liquid can be transported from the cavitation chamber 130 through the exit orifice 145 and exit the outlet 125, represented by arrow D.

In one embodiment, the smaller liquid jet 165 can penetrate and interact with the larger liquid jet 170 when the relative velocity between the two liquid jets 165, 170 reaches a certain threshold. For example, the smaller liquid jet 165 can penetrate and interact with the larger liquid jet 170 when the relative velocity between the two liquid jets 165, 170 is at least 10 meters/second. It will be appreciated that the relative velocity between the two liquid jets 165, 170 can be less than or greater than 10 meters/second depending on the viscosity, density, and/or temperature of the liquid stream.

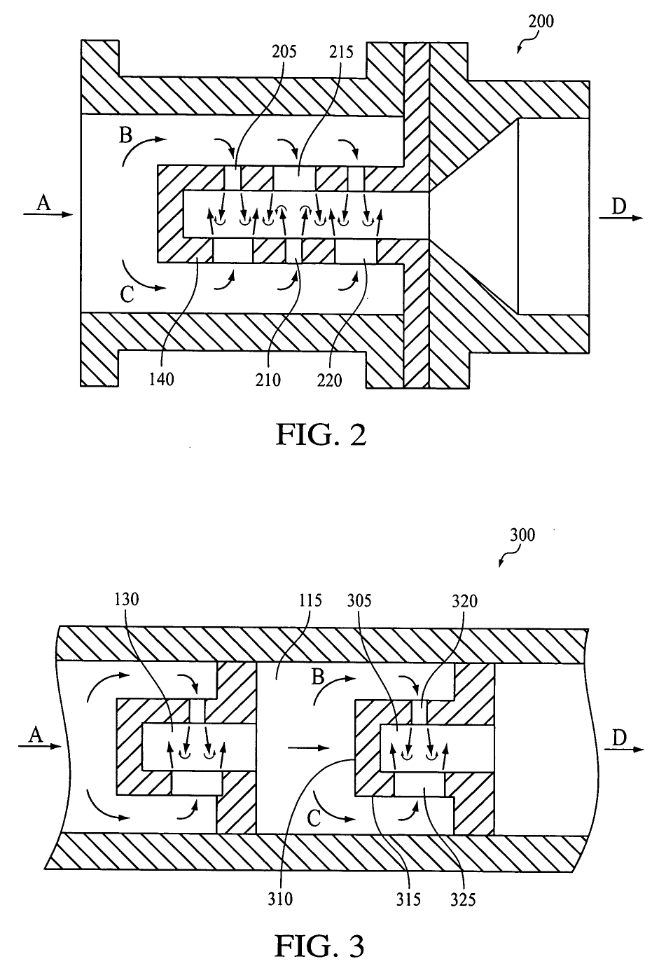

FIG. 2 illustrates a longitudinal cross-section of another embodiment of a device 200 for creating hydrodynamic cavitation. The device 200 is very similar in structure and function to the device 100 described above and illustrated in FIG. 1, except that the device 200 includes a second pair of opposing orifices 205, 210 and a third pair of opposing orifices 215, 220 in the side wall 140. As in the case of the device 100, each pair of opposing orifices can have different sized diameters.

FIG. 3 illustrates a longitudinal cross-section of another embodiment of a device 300 for creating hydrodynamic cavitation. The device 300 is very similar in structure and function to the device 100 described above and illustrated in FIG. 1, except that the device 300 includes a second cavitation chamber 305 provided in series with the first cavitation chamber 130 in the flow-through channel 115. The second cavitation chamber 305 can be defined by a front wall 310, at least one side wall 315 having a pair of opposing jetting orifices 325, 330, and an exit opening 335. Like device 100, the pair of opposing orifices 325, 330 can have different sized diameters.

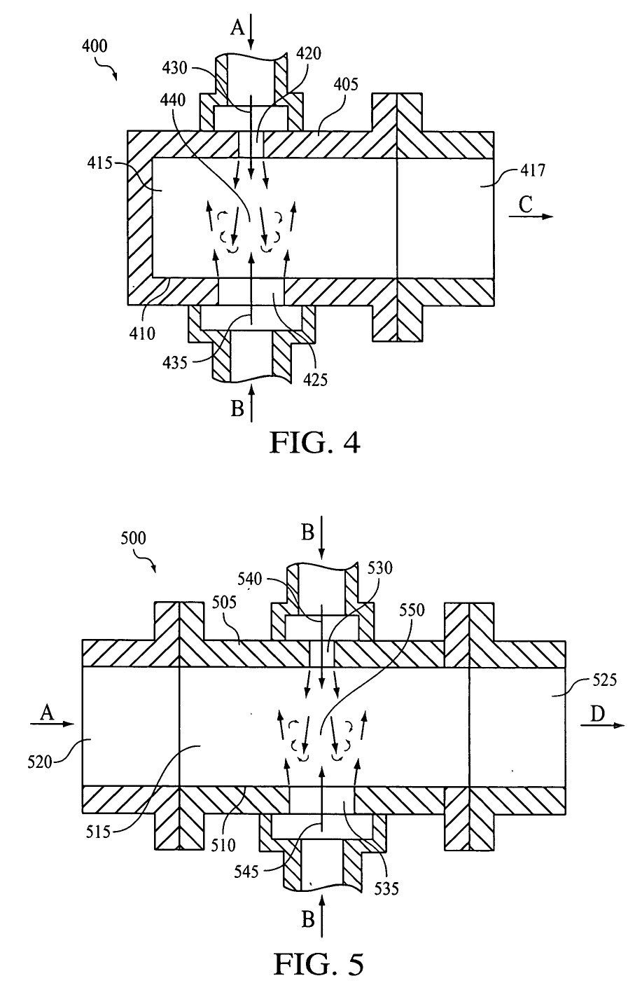

FIG. 4 a longitudinal cross-section of another embodiment of a device 400 for creating hydrodynamic cavitation. The device 400 can include at least one wall 405 having an inner surface 410 that defines a chamber 415. For example, the wall 405 can be a cylindrical wall that defines a flow-through channel having a circular cross-section. It will be appreciated that the cross-section of the chamber 415 may take the form of other geometric shapes such as square, rectangular, hexagonal, or any other complex shape. The chamber 415 can further include an outlet 417 configured to exit the liquid from the device 400.

In one embodiment, the wall 405 can include a first orifice 420 configured to permit the introduction of a first liquid stream into the chamber 415 and a second opposing orifice 425 configured to permit the introduction of a second liquid stream into the chamber 415. For example, the first orifice 420 and the second orifice 425 can directly face each other and share the same centerline C_{L}.

In one embodiment, the diameter of the first orifice 420 can be sufficiently smaller than the second orifice 425 to permit penetration of the first liquid stream into the second liquid stream. For example, the diameter of the first orifice 420 can be at least 10% less than the diameter of the second orifice 425 to provide adequate penetration of the first liquid stream into the second liquid stream.

In operation, a first liquid stream, represented by arrow A, can be introduced into the chamber 415 through the first orifice 420 thereby forming a liquid jet 430 (hereinafter referred to as “smaller liquid jet 430” because this liquid jet exits the smaller diameter orifice 420). Additionally, a second liquid stream, represented by arrow B, can be introduced into the chamber 415 through the second orifice 425 thereby forming a liquid jet 435 (hereinafter referred to as “larger liquid jet 435” because this liquid jet exits the smaller diameter orifice 425).

Both the smaller liquid jet 430 and the larger liquid jet 435 can flow into the chamber 415 where they can impinge along centerline C_{L}. Once the smaller liquid jet 430 and the larger liquid jet 435 collide, the smaller liquid jet 430 can penetrate and interact with the larger liquid jet 435 thereby creating a high shear intensity vortex contact layer 440 between the liquid jets 430, 435. As a result of this penetration and interaction, cavitation caverns and bubbles are created in the high shear intensity vortex contact layer 440. During the collapse of the cavitation caverns and bubbles, high localized pressures, up to 1000 MPa, arise and the level of energy dissipation in the chamber 415 attains a magnitude in the range of 1¹⁰-1¹⁵ watt/kg. Under these physical conditions in the liquid, on the boundary of the bubble and inside the bubble itself in the gas phase, chemical reactions proceed such as oxidation, disintegration, synthesis, etc. After the cavitation bubbles collapse, the liquid can exit through the outlet 417, represented by arrow C.

It will be appreciated that any type of chamber may be provided with a pair of opposing jetting orifices to practice the present invention. Suitable type of chambers may include tank, a pipe, a spherical vessel, a cylindrical vessel such as a drum, or any other desired shape. It is also contemplated that any size and shape may be possible provided that the liquid flow is permitted to enter the chamber. Such shapes may include cubical, conical, spherical, semi-spherical, or rectangular.

FIG. 5 illustrates a longitudinal cross-section of one embodiment of a device 500 for creating hydrodynamic cavitation. The device 500 can include at least one wall 505 having an inner surface 510 that defines a flow-through channel or chamber 515. For example, the wall 505 can be a cylindrical wall that defines a flow-through channel having a circular cross-section. It will be appreciated that the cross-section of flow-through channel 515 may take the form of other geometric shapes such as square, rectangular, hexagonal, or any other complex shape.

The flow-through channel 515 can further include an inlet 520 configured to introduce a liquid into the device 500 along a path, represented by arrow A, and an outlet 525 configured to exit the liquid from the device 500.

In one embodiment, the wall 505 can include a first orifice 530 configured to permit the introduction of a first liquid stream into the flow-through channel 515 and a second opposing orifice 535 configured to permit the introduction of a second liquid stream into the flow-through channel 515. For example, the first orifice 530 and the second orifice 535 can directly face each other and share the same centerline C_{L}.

In one embodiment, the diameter of the first orifice 530 can be sufficiently smaller than the second orifice 535 to permit penetration of the first liquid stream into the second liquid stream. For example, the diameter of the first orifice 530 can be at least 10% less than the diameter of the second orifice 535 to provide adequate penetration of the first liquid stream into the second liquid stream.

In operation, a first hydrodynamic liquid stream moves along the direction, represented by arrow A, through the inlet 520 and flows into the flow-through channel 515. As the liquid stream is passing through the flow-through channel 205, a second liquid stream, represented by arrow B, can be introduced through the first orifice 530 forming a liquid jet 540 (hereinafter referred to as “smaller liquid jet 540” because this liquid jet exits the smaller diameter orifice 530) that flows into the flow-through channel 515. Additionally, a third liquid stream, reprssented by arrow C, can be introduced through the second orifice 535 forming a liquid jet 545 (hereinafter referred to as “larger liquid jet 545” because this liquid jet exits the larger diameter orifice 535) that flows into the flow-through channel 515.

Both the smaller liquid jet 540 and the larger liquid jet 540 can flow into the flow-through channel 515 where they impinge along centerline C_{L}. Once the smaller liquid jet 540 and the larger liquid jet 545 collide, the smaller liquid jet 540 can penetrate and interact with the larger liquid jet 545 thereby creating a high shear intensity vortex contact layer 550 between the liquid jets 540, 545. As a result of this penetration and interaction, cavitation caverns and bubbles are created in the high shear intensity vortex contact layer 550. During the collapse of the cavitation caverns and bubbles, high localized pressures, up to 1000 MPa, arise and the level of energy dissipation in the flow-through channel 515 attains a magnitude in the range of 1¹⁰-1¹⁵ watt/kg. Under these physical conditions in the liquid, on the boundary of the bubble and inside the bubble itself in the gas phase, chemical reactions proceed such as oxidation, disintegration, synthesis, etc. After the cavitation bubbles collapse, the liquid can be transported from the flow-through channel 515 and exit via the outlet 525, represented by arrow D.

It will be appreciated that the aforementioned embodiments described above and illustrated in FIGS. 1-5 can be configured to receive liquid streams having the same or different characteristics, which can provide the operator with the ability to modify and control the desired cavitation effects. For example, the liquid streams discussed above may comprise the same liquid, different liquids, or any combination thereof. Each liquid stream may include a pure liquid, a liquid containing solid particles, a liquid containing droplets, an emulsion of multiple materials, a slurry, or a suspension. Additionally, each liquid may be introduced to the device under different physical conditions and chemical compositions. Such physical conditions may include pressure, flow rate, temperature, viscosity, and density. Such chemical compositions may include different chemical formulations and concentrations.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. A device for creating hydrodynamic cavitation in fluids comprising:
a chamber formed by at least one wall,
the wall having a first orifice configured to permit the introduction of a first liquid stream into the chamber and an opposing second orifice configured to permit the introduction of a second liquid stream into the chamber, wherein the first orifice has a diameter sufficiently smaller than the second orifice to permit penetration of the first liquid stream into the second liquid stream.

2. The device of claim 1, wherein the diameter of the first orifice is at least 10% smaller than the diameter of the second orifice.

3. The device of claim 1, further comprising a second pair of opposing orifices disposed in the wall such that the second pair of opposing orifices are in fluid communication with the chamber.

4. The device of claim 2, wherein the second pair of opposing orifices share the same centerline.

5. The device of claim 2, wherein the second pair of opposing orifices have different sized diameters.

6. A device for creating hydrodynamic cavitation in fluids comprising:
a housing having at least one wall defining an interior,
the wall having a first orifice configured to permit the introduction of a first liquid stream into the interior and an opposing second orifice configured to permit the introduction of a second liquid stream into the interior, wherein the first orifice and second orifice generally share the same center-line and the first orifice has a diameter sufficiently smaller than the second orifice to permit penetration of the first liquid stream into the second liquid stream.

7. A device for creating hydrodynamic cavitation in fluids comprising:
a flow-through channel having at least one wall,
the wall having a first orifice that is in communication with the flow-through channel for introducing a first liquid stream into the flow-through channel,
the wall having a second orifice opposite the first orifice that is in communication with the flow-through channel for introducing a second liquid stream into the flow-through channel,
wherein the first orifice and second orifice share the same center-line and the first orifice has a diameter sufficiently smaller than the second orifice to permit penetration of the first liquid stream into the second liquid stream.

8. The device of claim 7, wherein introduction of the first liquid stream through the first orifice creates a first liquid jet and introduction of the second liquid stream through the second orifice creates a second liquid jet.

9. The device of claim 8, wherein the first liquid jet impinges with the second liquid jet such that the first liquid jet penetrates and interacts with the second liquid jet thereby creating a high intensity shear layer.

10. The device of claim 7, wherein the flow-through channel is configured for passing a hydrodynamic liquid through said flow-through channel.

11. The device of claim 7, wherein the diameter of the first orifice is at least 10% smaller than the diameter of the second orifice.

12. A device for creating hydrodynamic cavitation in fluids comprising:
a flow-through channel for passing a hydrodynamic liquid, the flow-through channel having an outlet;
a cavitation chamber situated within the flow-through channel, the cavitation chamber defined by at least one wall and an exit orifice wherein:
the wall includes a first orifice configured to permit the introduction of a first liquid stream into the chamber and an opposing second orifice configured to permit the introduction of a second liquid stream into the chambers wherein the first and second orifices are generally aligned with each other and the first orifice has a diameter sufficiently smaller than the second orifice to permit penetration of the first liquid stream into the second liquid stream, and
the exit orifice is in communication with the outlet;
a restriction wall in physical communication with the wall and the flow-through channel to prevent the hydrodynamic liquid from exiting the flow-through channel before entering the first and second orifices.

13. The device of claim 12, further comprising a second cavitation chamber situated within the flow-through channel in series with the first cavitation chamber, the second cavitation chamber having a pair of opposing orifices that are generally aligned with each other and have different diameters.

14. The device of claim 12, wherein the wall includes a second pair of opposing orifices that are generally aligned with each other and have different diameters.

15. A method of creating hydrodynamic cavitation in a chamber defined by at least one wall, the method comprising the steps of:
introducing a first liquid stream through a first orifice in the wall to create a first liquid jet;
introducing a second liquid stream through a second opposing orifice in the wall to create a second liquid jet that interacts with and penetrates the first liquid jet thereby creating a high shear intensity vortex contact layer resulting in hydrodynamic cavitation.

16. The method of claim 15, wherein the relative velocity between the first and second liquid jets is at least 10 meters/second.

17. A method of creating hydrodynamic cavitation in fluids, the method comprising the steps of:
passing a hydrodynamic liquid through a flow-through channel having at least one wall;
introducing a first liquid stream through a first orifice in the wall to create a first liquid jet;
introducing a second liquid stream through a second opposing orifice in the wall to create a second liquid jet that interacts with and penetrates the first liquid jet thereby creating a high shear intensity vortex contact layer; and
creating a high shear intensity vortex contact layer when the first liquid jet interacts with and penetrates the second liquid jet thereby creating hydrodynamic cavitation.

18. The method of claim 17, further comprising the step of creating and collapsing cavitation caverns and bubbles in the high shear intensity vortex contact layer.

19. The method of claim 17, wherein the relative velocity between the first and second liquid jets is at least 10 meters/second.
